(19) United States
(12) Patent Application Publication
(10) Pub. No.: US 2020/0408086 A1
(43) Pub. Date: Dec. 31, 2020

(54) METHOD AND SYSTEM FOR NON-INTRUSIVELY DETERMINING CROSS-SECTIONAL VARIATION FOR A FLUIDIC CHANNEL

(71) Applicant: HALLIBURTON ENERGY SERVICES, INC., Houston, TX (US)

(72) Inventor: Srinivasan JAGANNATHAN, Houston, TX (US)

(73) Assignee: HALLIBURTON ENERGY SERVICES, INC., Houston, TX (US)

(21) Appl. No.: 16/980,161

(22) PCT Filed: Aug. 8, 2018
(86) PCT No.: PCT/US2018/045712

§ 371 Date: Sep. 11, 2020

Related U.S. Application Data
(60) Provisional application No. 62/656,873, filed on Apr. 12, 2018.

(51) Int. Cl. E21B 47/09; G01B 13/10

(52) U.S. Cl. CPC E21B 47/09; G01B 13/10

(57) ABSTRACT

A method is provided for non-intrusively determining cross-sectional variation of a fluidic channel. The method includes obtaining, from one or more sensors, a measured pressure profile based on at least one pressure pulse induced in a fluidic channel. A forward model of cross-sectional variation of the fluidic channel is generated. Using the forward model, a simulated pressure profile is generated. Using the measured pressure profile and the simulated pressure profile, an error is determined. When the error is outside a predetermined threshold, the forward model is updated based on the error.

### CROSS-REFERENCE TO RELATED APPLICATION

This application claims priority to U.S. Provisional Patent Application No. 62/656,873, filed in the U.S. Patent and Trademark Office on Apr. 12, 2018, all of which is incorporated herein by reference in its entirety for all purposes.

### FIELD

The present disclosure relates generally to determining cross-sectional variations of a fluidic channel. In particular, in at least one aspect, the present disclosure relates, in part, to inverse models for non-intrusively determining cross-sectional shape variations of a fluidic channel.

### BACKGROUND

Wellbores are drilled into the earth for a variety of purposes including tapping into hydrocarbon bearing formations to extract the hydrocarbons for use as fuel, lubricants, chemical production, and other purposes. These hydrocarbons are often transmitted to processing plants via pipelines. Fluidic channels such as pipelines and wellbores need to be inspected to determine issues such as leaks, blockages by deposits, or structural erosion or damage.

Most methods for monitoring the integrity of fluidic channels are intrusive, such as using pigs, overhead drones, low flying airplanes, and the like. These methods can entail considerable investments in money and time.

### BRIEF DESCRIPTION OF THE DRAWINGS

Implementations of the present technology will now be described, by way of example only, with reference to the attached figures, wherein:

FIG. 1A is a schematic diagram of an exemplary environment for a system for determining cross-sectional variation of a fluidic channel according to the present disclosure;

FIG. 1B is a schematic cross-sectional diagram of a fluidic channel where the fluidic channel does not have cross-sectional variations taken along line 1B-1B of FIG. 1A;

FIG. 1C is a schematic cross-sectional diagram of a fluidic channel with cross-sectional variations taken along line 1C-1C of FIG. 1A;

FIG. 2 is a schematic diagram of a data acquisition system which may be employed as shown in FIG. 1A;

FIG. 3 is a flow chart of a method for generating a model of cross-sectional variation;

FIG. 4 is an exemplary diagram of a measured pressure profile;

FIG. 5 is an exemplary diagram of a baseline simulation of a pressure profile;

FIG. 6 is a flow chart of a method for outputting a forward model of deposits;

FIG. 7 is an exemplary diagram of area ratio as a function of cross-sectional variation; and

FIG. 8 is an exemplary diagram of a model of cross-sectional variations of a fluidic channel.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Disclosed herein are systems and methods for non-intrusively determining cross-sectional variation of a fluidic channel. In one or more examples, a measured pressure profile is obtained using pressure pulse technology which is then used to iteratively improve an estimation of cross-sectional variation of a fluid channel. When the error between the measured pressure profile and the modeled cross-sectional variation is within a curtained predefined threshold, a final cross-sectional variation is output as a function of range to show location of cross-sectional variation of the fluidic channel.

In order to obtain a measured pressure profile, pressure pulses are induced in the fluidic channel. Pressure pulses can be induced, for example, by a device including a valve which can be opened and closed. By closing the valve, a pressure pulse can be generated. One or more sensors measure a pressure profile based on the pressure pulses reflecting off of cross-sectional variations of the fluidic channel. The measured pressure profile may be then forwarded to a data acquisition system, or a processing unit.

The data acquisition system also generates a forward model of cross-sectional variation of the fluidic channel. The forward model may be generated using an initial estimate of the cross-sectional shape at desired grid points and data regarding the pressure pulses. Based on the forward model, a simulated pressure profile is generated. An error is calculated using the measured pressure profile and the simulated pressure profile. If the error is not within a predetermined threshold, or in other words, when the error is too high or outside of the predetermined threshold, then the inputs to the forward model are updated. The updated forward model is adjusted based on the error. With the updated forward model, another simulated pressure profile is generated, and the error is calculated. If the error is once again outside of the predetermined threshold, then updating the forward model and subsequent steps are repeated until the error is within the predetermined threshold. If the error is within the predetermined threshold, then the forward model is output, and a model of cross-sectional variation of the fluidic channel is generated. Since the inputs to the forward model are updated based on the error, this method may reduce the time for processing loads and enables processing completion, for instance, by a factor of greater than 100. The resolution of such an inversion scheme can also be much higher. For example, instead of the resolution being in terms of kilometers, the resolution utilizing the method can provide resolution in terms of meters.

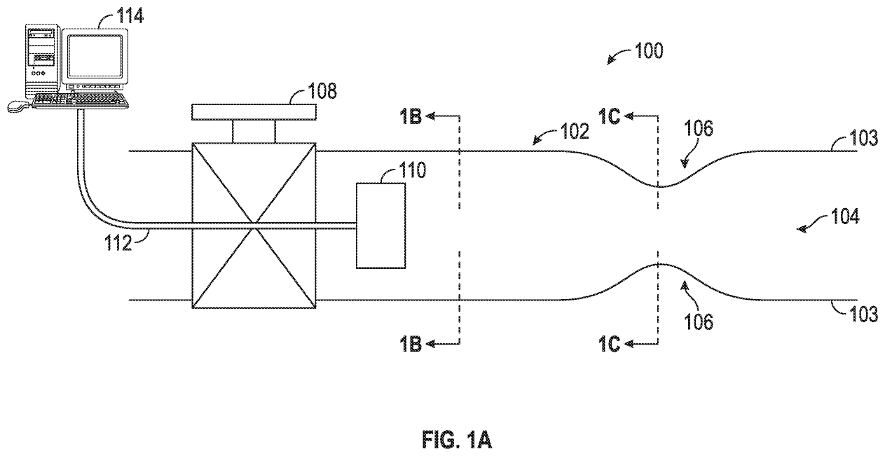

The method can be employed in an exemplary system 100 shown, for example, in FIGS. 1A-1C. FIG. 1A is a schematic diagram illustrating a fluidic channel 102. The fluidic channel 102 illustrated in FIG. 1A is a pipeline. In other examples, the fluidic channel 102 can be, for example, a pipeline, a wellbore, a drill string, or any channel through which fluid flows. The portion of the fluidic channel 102 may have any orientation or extend only in one direction or multiple directions, for example vertical or at an angle, along any axis, and may be but is not required to be horizontal as schematically depicted in FIG. 1A. The fluidic channel 102 has walls 103 which form an annulus 104 through which fluid can be contained in and flow. The fluid can be one fluid or more than one fluid. The fluid can include, for example, water or oil. The fluid can also substantially fill the entire fluidic channel 102. In other examples, the fluid can partially fill the fluidic channel 102. The walls 103 of the fluidic channel 102 can form a cross-sectional shape such as substantially circular, ovoid, rectangular, or any other suitable shape. The walls 103 of the fluidic channel 102 can be made of any combination of plastics or metals, suitable to withstand fluid flow without corrosion and with minimal deformation.

Along the fluidic channel 102, cross-sectional variations 106 of the fluidic channel 102 may form. The cross-sectional variations 106 can be a change of shape and/or cross-sectional area, for example, of the fluidic channel 102 any amount and in any shape and form to impede flow of the fluid. For example, in some areas, the cross-sectional variations 106 may completely block the annulus 104 of the fluidic channel 102. Additionally, the cross-sectional variations 106 may be to such an extent as to cause structural damage such as cracks in the walls 103 of the fluidic channel 102.

In some areas, as indicated for example by lines 1B-1B and FIG. 1B, the fluidic channel 102 does not have any cross-sectional variations 106. FIG. 1B is a schematic cross-sectional diagram illustrating the fluidic channel 102 as substantially circular. As discussed above, the cross-sectional shape of the fluidic channel 102 can be any suitable shape as desired. In yet other areas, as indicated for example by lines 1C-1C and FIG. 1C, the fluidic channel 102 may have cross-sectional variations 106. FIG. 1C is a schematic cross-sectional diagram illustrating the fluidic channel 102 with the cross-sectional variation 106 has a substantially ovoid shape. The change in shape of the fluidic channel 102 by the cross-sectional variation 106 can be any other shape, such as rectangular, diamond, triangular, irregular, or any other possible shape. As illustrated in FIG. 1A, the fluidic channel 102 has one portion with cross-sectional variations 106. In other examples, the fluidic channel 102 can be more than one portion with cross-sectional variations 106. In yet other examples, the fluidic channel 102 may not have any portions with cross-sectional variations 106.

Cross-sectional variation 106 can include change in cross-sectional shape. Change in cross-sectional shape can be determined, for example, by change in a shape parameter. Shape parameter can be, for example, a dimension over a vertical axis and a horizontal axis, or a major axis and a minor axis. If the perimeter, or circumference, of the fluidic channel 102 remains constant during the change in cross-sectional shape, the cross-sectional area of the fluidic channel 102 will also change.

As the fluid flows through the fluidic channel 102 from a portion without cross-sectional variations 106 through a portion with cross-sectional variations 106, the fluid may experience turbulent flow. In at least one example, the fluid may be prevented from flowing across the portion of the fluidic channel 102 with cross-sectional variations 106.

To obtain the measured profile, and inspect the fluidic channel 102 in a non-intrusive manner, at least one pressure pulse, such as a water-hammer pulse, can be induced. To induce the pressure pulses, a device 108 can be used. The device 108 can be actuated to create a pressure pulse that travels through the fluidic channel 102 at the local speed of sound in the medium. An example of a device 108 is used in the InnerVue™ Service by Halliburton Energy Services, Inc. In at least one example, the device 108 is not a permanent fixture or attachment. As such, the device 108 can be disposed in the fluidic channel 102 or coupled with the fluidic channel 102 only when needed to create pressure pulses. In other examples, the device 108 can be a permanent fixture in the fluidic channel 102. The device 108 can be, for example, a valve. The device 108 can be actuated and create the pressure pulse by opening and closing the valve. When the valve is shut, a pressure pulse is generated that travels upstream of the valve. The device 108 can be electrically programmed, such that different pressures can be induced based on the open and close sequences. The quicker the valve is opened and closed, the greater, or sharper, the pressure pulse.

As the pressure pulse travels along the fluidic channel 102, any encountered obstructions or cross-sectional variations 106 generate a reflected signal which is received back at the device 108. The system 100 includes a sensor 110 to receive the reflected pressure pulse signals. The sensor 110 can be a known distance from the device 108. The sensor 110 can be a pressure transducer. In other examples, the sensor 110 can be any suitable sensor that measures pressure or stress of the fluid, for example a string gauge or an optical fiber transducer. The reflected signals are then passed through a transmission system 112 to a data acquisition system 114 to be interpreted to map out and quantify any deposits 106 in the fluidic channel 102. The data acquisition system 114 can be at the surface, within a vehicle such as a submarine, or any other suitable location such that the data can be interpreted by an operator. The transmission system 112 can be wireline, optical fiber, wirelessly such as through the cloud or Bluetooth, or any other suitable method to transmit data.

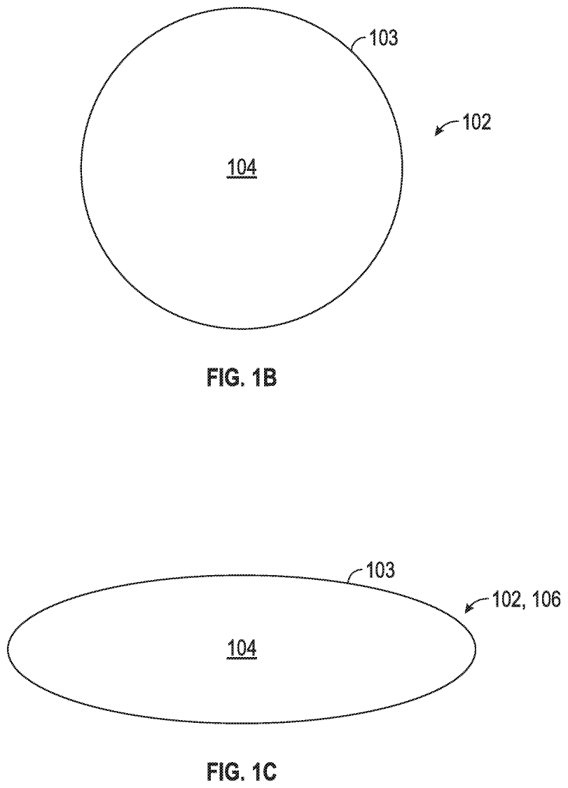

FIG. 2 is a block diagram of an exemplary data acquisition system 114. Data acquisition system 114 is configured to perform processing of data and communicate with the sensors 110, for example as illustrated in FIG. 1A. In operation, data acquisition system 114 communicates with one or more of the above-discussed components and may also be configured to communication with remote devices/systems.

As shown, data acquisition system 114 includes hardware and software components such as network interfaces 210, at least one processor 220, sensors 260 and a memory 240 interconnected by a system bus 250. Network interface(s) 210 can include mechanical, electrical, and signaling circuitry for communicating data over communication links, which may include wired or wireless communication links. Network interfaces 210 are configured to transmit and/or receive data using a variety of different communication protocols, as will be understood by those skilled in the art.

Processor 220 represents a digital signal processor (e.g., a microprocessor, a microcontroller, or a fixed-logic processor, etc.) configured to execute instructions or logic to perform tasks in a wellbore environment. Processor 220 may include a general purpose processor, special-purpose processor (where software instructions are incorporated into the processor), a state machine, application specific integrated circuit (ASIC), a programmable gate array (PGA) including a field PGA, an individual component, a distributed group of processors, and the like. Processor 220 typically operates in conjunction with shared or dedicated hardware, including but not limited to, hardware capable of executing software and hardware. For example, processor 220 may include elements or logic adapted to execute software programs and manipulate data structures 245, which may reside in memory 240.

Sensors 260, which may include sensors 110 as disclosed herein, typically operate in conjunction with processor 220 to perform measurements, and can include special-purpose processors, detectors, transmitters, receivers, and the like. In this fashion, sensors 260 may include hardware/software for generating, transmitting, receiving, detection, logging, and/or sampling magnetic fields, seismic activity, and/or acoustic waves, or other parameters.

Memory 240 comprises a plurality of storage locations that are addressable by processor 220 for storing software programs and data structures 245 associated with the embodiments described herein. An operating system 242, portions of which may be typically resident in memory 240 and executed by processor 220, functionally organizes the device by, inter alia, invoking operations in support of software processes and/or services 244 executing on data acquisition system 114. These software processes and/or services 244 may perform processing of data and communication with data acquisition system 114, as described herein. Note that while process/service 244 is shown in centralized memory 240, some examples provide for these processes/services to be operated in a distributed computing network.

It will be apparent to those skilled in the art that other processor and memory types, including various computer-readable media, may be used to store and execute program instructions pertaining to the fluidic channel evaluation techniques described herein. Also, while the description illustrates various processes, it is expressly contemplated that various processes may be embodied as modules having portions of the process/service 244 encoded thereon. In this fashion, the program modules may be encoded in one or more tangible computer readable storage media for execution, such as with fixed logic or programmable logic (e.g., software/computer instructions executed by a processor, and any processor may be a programmable processor, programmable digital logic such as field programmable gate arrays or an ASIC that comprises fixed digital logic. In general, any process logic may be embodied in processor 220 or computer readable medium encoded with instructions for execution by processor 220 that, when executed by the processor, are operable to cause the processor to perform the functions described herein.

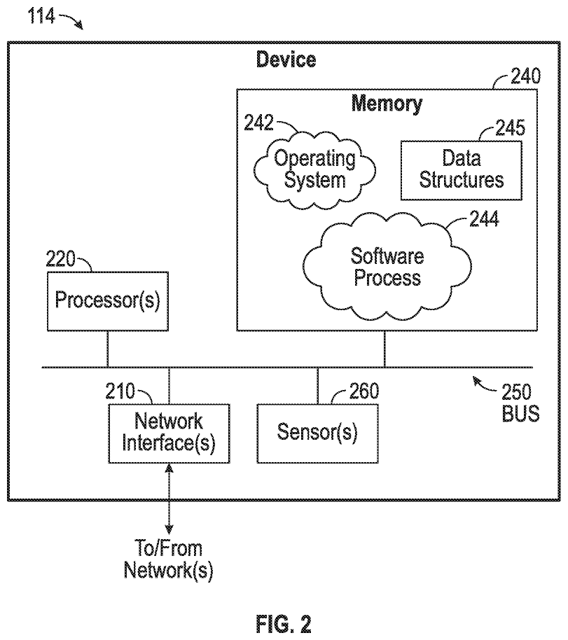

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1A-2 and 4-8, for example, and various elements of these figures are referenced in explaining example method 300. Each block shown in FIG. 3 represents one or more processes, methods or subroutines, carried out in the example method 300. Furthermore, the illustrated order of blocks is illustrative only and the order of the blocks can change according to the present disclosure. Additional blocks may be added or fewer blocks may be utilized, without departing from this disclosure. The example method 300 can begin at block 302.

At block 302, a pressure pulse is induced in a fluidic channel as described above. For instance, one or more pressure pulses can be induced. For example, a sequence of pressure pulses of differing sharpness can be induced. In other examples, the pressure pulses may all have the same sharpness. In yet other examples, only one pressure pulse is induced. The pressure pulse is induced by a device which can be a valve. By opening and closing the valve, a pressure pulse is induced. The faster the valve is closed, the sharper the pressure pulse. The pressure pulse travels upstream in the fluidic channel and reflects off of any obstructions such as deposits in the fluidic channel.

At block 304, the pressure fluctuations are then recorded by one or more sensors. The data is then transmitted to a data acquisition system to interpret the data.

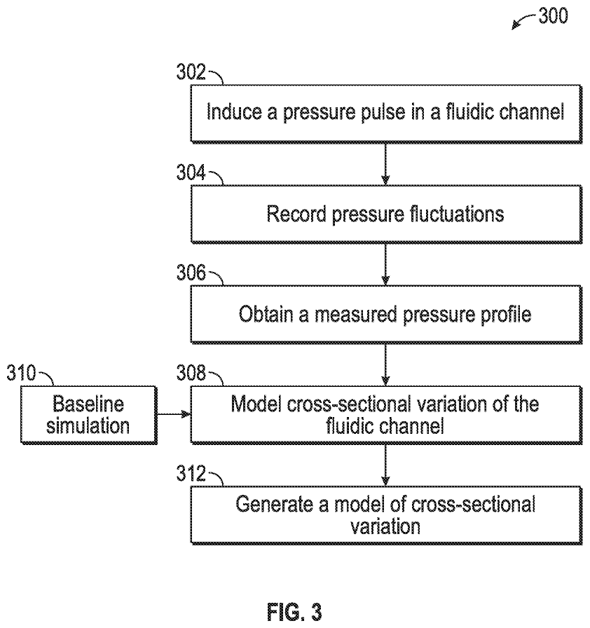

At block 306, a measured pressure profile is obtained. The measured pressure profile, as shown in FIG. 4, is provided as a diagram 300 of pressure versus time. Section 402 of the diagram 400 illustrates the pressure spike created by the opening and closing of the valve. The quicker the valve is closed, the sharper the pressure spike. Section 404 of the diagram 400 illustrates pressure fluctuations which correspond to obstructions such as cross-sectional variations of the fluidic channel.

Referring back to FIG. 3, at block 308, the cross-sectional variations of the fluidic channel are modeled. The modeling can be performed by a data acquisition system which includes a non-transitory computer readable storage medium. The non-transitory computer readable storage medium includes at least one processor and stores instructions executable by the at least one processor. To model the cross-sectional variations, a baseline simulation, at block 310, may be used. The baseline simulation is a simulation of the fluidic channel if there are no cross-sectional variations. The baseline simulation can be calculated using hydrodynamic equations by knowing information about the fluidic channel such as the fluid, the diameter and shape, the pressure pulse that would be created by the device, among other known data.

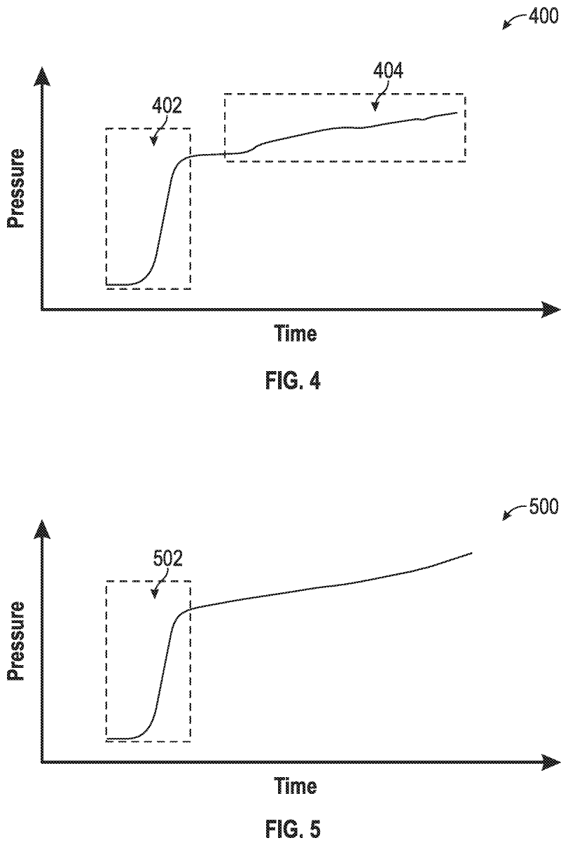

From the baseline simulation, a simulated pressure profile, as illustrated in FIG. 5, can be created. As shown in FIG. 5, similar to the measured pressure profile in FIG. 4, a simulated pressure profile is provided as a diagram 500 of pressure versus time. Section 502 of the diagram 500 illustrates the pressure spike created by the opening and closing of the valve. However, different than the measured pressure profile of FIG. 4, there are no fluctuations in the pressure, as the simulated pressure profile is based on the baseline simulation which assumes that there are no cross-sectional variations of the fluidic channel. If there are known cross-sectional variations which would cause fluctuations in the fluidic channel, those may be shown in the simulated pressure profile.

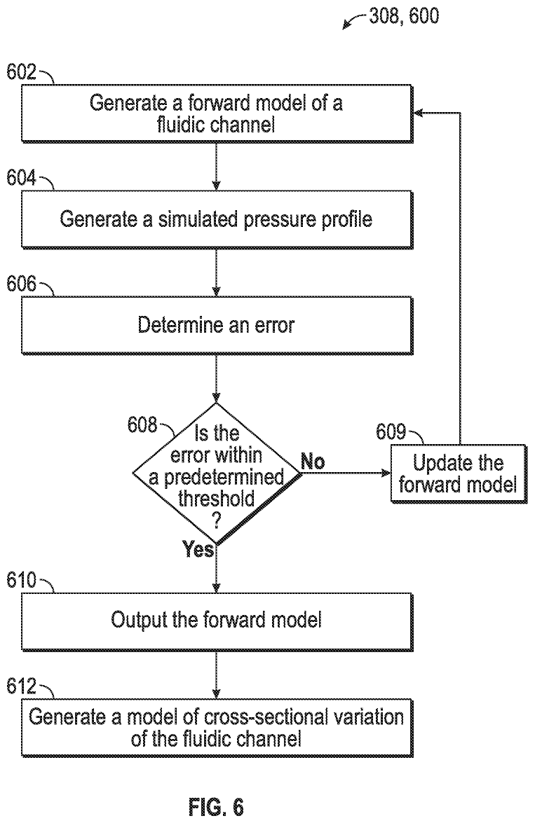

The model of the cross-sectional variations is then created by comparing the simulated pressure profile with the measured pressure profile and adjusting the simulated pressure profile until the simulated pressure profile and the measured pressure profile substantially match. To substantially match, the error between the simulated pressure profile and the measured pressure profile must fall within a predetermined threshold. Modeling the cross-sectional variations will be described in further detail in FIG. 6 below.

Referring back to FIG. 3, at block 312, if the simulated pressure profile and the measured pressure profile are substantially matching, an estimate of cross-sectional variations of the fluidic channel is generated.

Referring to FIG. 6, a flowchart is presented in accordance with an example embodiment for modeling a cross-sectional variation of a fluidic channel, for example block 308 of FIG. 3. The method 600 is provided by way of example, as there are a variety of ways to carry out the method. The method 600 described below can be carried out using the configurations illustrated in FIGS. 1-5, for example, and various elements of these figures are referenced in explaining example method 600. Each block shown in FIG. 6 represents one or more processes, methods or subroutines, carried out in the example method 600. Furthermore, the illustrated order of blocks is illustrative only and the order of the blocks can change according to the present disclosure. Additional blocks may be added or fewer blocks may be utilized, without departing from this disclosure. The example method 600 can be implemented using a data acquisition system, for example data acquisition system 114 as shown in FIGS. 1A and 2, which includes a non-transitory computer readable storage medium. The non-transitory computer readable storage medium includes at least one processor and stores instructions executable by the at least one processor to implement the example method 600. The example method 600 can begin at block 602.

At block 602, a forward model of a fluidic channel is generated. In this case, the forward model may be generated using water-hammer fluid dynamic equations, for example Joukowsky equations or other suitable methods for calculating a forward model of a fluidic channel using a pressure pulse. While the cross-sectional shape that is discussed in this disclosure is ovality or circularity, any suitable shape can apply, and the calculations may be adjusted accordingly. An approximate expression for the change in pressure can be provided, for example, by the Jowkowski equations as:

Δp=−ρcΔv (1)

where Δp is a change in pressure, ρ is a density of fluid, c is the sound speed of the fluid, and Δv is a local change in fluid velocity. For example, it can be assumed that the density and sound speed remain constant along a fluidic channel. Then, any reflection (or change in pressure) of the pressure pulse would be due to a change in fluid velocity. If the volume flow rate is assumed to be constant Q, then the velocity at any point along the fluidic channel can be determined by:

v=Q/A (2)

where A is a cross-sectional area at a portion along the fluidic channel. The change in velocity is then determined by:

Δv=−Q(ΔA)A² (3)

where ΔA is a change in cross-sectional area at the portion along the fluidic channel. In at least one example, if the cross-sectional area stays the same along a fluidic channel, a change in velocity can still occur if there is a change in the volume flow rate Q which can happen, for example, if there is a leak in the pipeline. As such, the change in velocity can be determined by:

Δv=−ΔQ/A. (4)

The cross-sectional area of a fluidic channel can also vary due to a change in shape, such as an ovality in the fluidic channel. In the present example, it is assumed that the cross-section of the fluidic channel is changed from a circle of diameter D to an ellipse. The eccentricity of the ellipse is determined by:

$$e = \sqrt{1 - \frac{{b}^{2}}{{a}^{2}}} \qquad ( 5 )$$

where a is the major axis and b is the minor axis of the ellipse. The perimeter of the circle should be the same as that of the ellipse; as such:

$$2 π \sqrt{\frac{{a}^{2} + {b}^{2}}{2}} = 2 π D / 2. \qquad ( 6 )$$

The left-hand-side (LHS) of equation (6) is an approximate expression for the perimeter of an ellipse. Solving for a and b in terms of the cross-sectional variation yields:

$$\begin{matrix}{a}^{2} = \frac{{D}^{2}}{2 ( 2 - {e}^{2} )} & ( 7 ) \\ {b}^{2} = \frac{( 1 - {e}^{2} ) {D}^{2}}{2 ( 2 - {e}^{2} )} & ( 8 )\end{matrix}$$

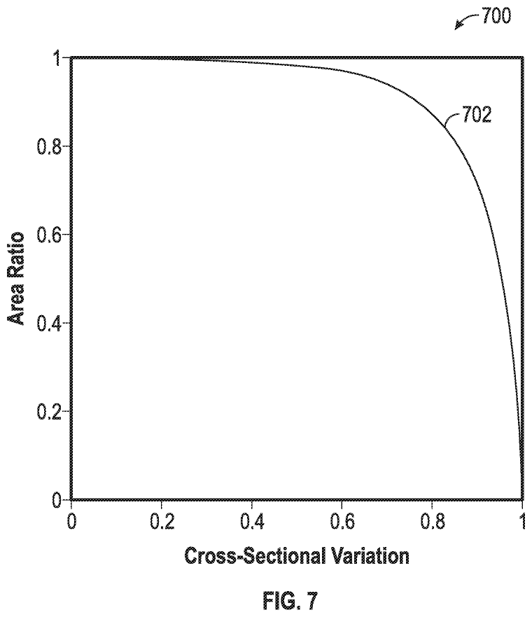

Further, the ratio of the cross-sectional area of the ellipse to that of the original circle is given by equation (9) below, for which a plot of the ratio is shown in FIG. 7.

$$\frac{{A}_{e}}{{A}_{c}} = \frac{2 \sqrt{1 - {e}^{2}}}{( 2 - {e}^{2} )} \qquad ( 9 )$$

While the above equations are used to calculate the forward model from pressure changes, the above equations are exemplary. Other methods to calculate cross-sectional variations from pressure changes can be used as applicable.

The forward model is based on the baseline simulation. The forward model incorporates an initial guess at cross-sectional variations, or estimated cross-sectional variations, at desired grid points. The grid points may be 1 meter, 10 meters, 20 meters, 100 meters, or any desired resolution. The initial guess at cross-sectional variations includes, for example, any known cross-sectional variations. The known cross-sectional variations may be known because of previous experience or known cross-sectional variations of the fluidic channel. The initial guess at cross-sectional variations can also be set at 0, which provides that no cross-sectional variations are known.

The forward model also incorporates a valve closing profile. The valve closing profile includes how the device created a pressure pulse, for example, how fast the valve was closed and/or the sequences of opening and closing the valve. As such, the valve closing profile includes the known information of the pressure pulses and known reflections that would occur from any known cross-sectional variations of the fluidic channel.

At block 604, a simulated pressure profile is generated from the forward model. The simulated pressure profile is a diagram of pressure versus time and reflects the initial pressure spike from the device creating the pressure pulse and pressure fluctuations from the pressure pulse reflecting off of estimated cross-sectional variations of the fluidic channels such as deposits.

At block 606, an error is determined. The error indicates an amount that the simulated pressure profile does not correspond to the measured pressure profile. To calculate the error, the measured pressure profile from the at least one sensor is utilized. The error is calculated based on the difference between the measured pressure profile and the simulated pressure profile. The error can be calculated using the equation:

Error=|measured pressure profile−simulated pressure profile|².

At block 608, the error is compared with a predetermined threshold. If the error is not within the predetermined threshold, the forward model is updated at block 609. The updated inputs (for example the cross-sectional variations as a function of range) to the forward model can be calculated using the equation:

Updated cross-sectional variation=current cross-sectional variation+function(error).

As such, the forward model is adjusted based on the error. The steps of generating a forward model 602, generating a simulated pressure profile 604, determining an error 606, determining whether the error is within, or less than, a predetermined error 608, and updating the forward model 609 are repeated until the error is within the predetermined threshold.

By basing the adjustments to the forward model on the error, the processing time can be reduced, for example, from 2 to 4 hours to 2 to 5 minutes on average.

If the error is within the predetermined threshold, then at block 610, the forward model is outputted.

At block 612, an estimate of cross-sectional variations of the fluidic channel is then generated and outputted. When a pressure disturbance is created in a fluidic channel, the pressure pulse travels as a wave with a speed equal to the local sound speed of the fluid within the fluidic channel. As the pressure pulse travels, any changes to the fluidic channel characteristic (or impedance) results in reflection of at least a portion of the fluidic channel.

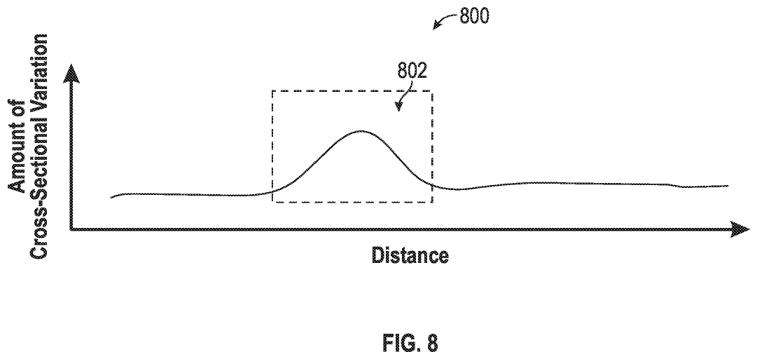

FIG. 8 illustrates an exemplary diagram 800 of a model or an estimate of cross-sectional variations of the fluidic channel. The exemplary diagram 800 provides for amount of cross-sectional variations versus distance from the device and/or sensor. As illustrated in FIG. 8, the model of cross-sectional variations of the fluidic channel provides for a visualization of the amount cross-sectional variation at each point of the fluidic channel. For example, as illustrated in FIG. 8, the fluidic channel has cross-sectional variations at the distance corresponding to range 702.

After the model of cross-sectional variations is generated and outputted, adjustments to the fluidic channel can be made. For example, the fluidic channel can be inspected at certain points with greater cross-sectional variation. In other examples, the portion of the fluidic channel with cross-sectional variation can be repaired and/or replaced by any suitable method.

Numerous examples are provided herein to enhance understanding of the present disclosure. A specific set of statements are provided as follows.

Statement 1: A method is disclosed for non-intrusively determining cross-sectional variation of a fluidic channel, the method comprising: obtaining, from one or more sensors, a measured pressure profile based on at least one pressure pulse induced in a fluidic channel; generating a forward model of cross-sectional variation of the fluidic channel; generating, using the forward model, a simulated pressure profile; determining, using the measured pressure profile and the simulated pressure profile, an error; and updating, when the error is outside a predetermined threshold, the forward model based on the error.

Statement 2: A method is disclosed according to Statement 1, further comprising: actuating a device to create a pressure pulse in the fluidic channel.

Statement 3: A method is disclosed according to Statement 2, wherein the device includes a valve, the valve is configured to be opened and closed to generate the pressure pulse.

Statement 4: A method is disclosed according to any of preceding Statements 1-3, further comprising: outputting, when the error is within the predetermined threshold, the forward mode; generating, using the forward model, an estimate of cross-sectional variation of the fluidic channel; and outputting the estimate of cross-sectional variation of the fluidic channel.

Statement 5: A method is disclosed according to Statement 4, wherein the estimate of cross-sectional variation is provided as a function of amount of estimated cross-sectional variation of the fluidic channel versus distance in the fluidic channel from the one or more sensors.

Statement 6: A method is disclosed according to any of preceding Statements 1-5, further comprising: repeating, until the error is within the predetermined threshold, generating the forward model, generating the simulated pressure profile, determining the error, and updating the forward model.

Statement 7: A method is disclosed according to any of preceding Statements 1-6, wherein the cross-sectional variation includes a shape change of the fluidic channel and/or a change of cross-sectional area of the fluidic channel.

Statement 8: A system is disclosed for non-intrusively determining cross-sectional variation of a fluidic channel, the system comprising: a device operable to induce at least one pressure pulse in a fluidic channel; one or more sensors operable to measure a pressure profile based on the at least one pressure pulse; and a non-transitory computer readable storage medium including at least one processor and storing instructions executable by the at least one processor to: obtain, from the one or more sensors, the measured pressure profile; generate a forward model of cross-sectional variation of the fluidic channel; generate, using the forward model, a simulated pressure profile; determine, using the measured pressure profile and the simulated pressure profile, an error; and update, when the error is outside a predetermined threshold, the forward model based on the error.

Statement 9: A system is disclosed according to Statement 8, wherein the device includes a valve, the valve is configured to be opened and closed to generate the pressure pulse.

Statement 10: A system is disclosed according to Statements 8 or 9, wherein the instructions further include to: output, when the error is within the predetermined threshold, the forward model; generate, using the forward model, an estimate of cross-sectional variation of the fluidic channel; and output the estimate of cross-sectional variation of the fluidic channel.

Statement 11: A system is disclosed according to Statement 10, wherein the estimate of cross-sectional variation is provided as a function of amount of estimated cross-sectional variation of the fluidic channel versus distance in the fluidic channel from the one or more sensors.

Statement 12: A system is disclosed according to any of preceding Statements 8-11, wherein the instructions further include to: repeat, until the error is within the predetermined threshold, generate the model, generate the simulated pressure profile, determine the error, and update the forward model.

Statement 13: A system is disclosed according to any of preceding Statements 8-12, wherein the cross-sectional variation includes a shape change of the fluidic channel.

Statement 14: A system is disclosed according to any of preceding Statements 8-13, wherein the cross-sectional variation includes a change of cross-sectional area of the fluidic channel.

Statement 15: A non-transitory computer readable storage medium is disclosed comprising at least one processor and storing instructions executable by the at least one processor to: obtain, from one or more sensors, a measured pressure profile based on at least one pressure pulse inducted in a fluidic channel; generate a forward model of cross-sectional variation of the fluidic channel; generate, using the forward model, a simulated pressure profile; determine, using the measured pressure profile and the simulated pressure profile, an error; and update, when the error is outside a predetermined threshold, the forward model based on the error.

Statement 16: A non-transitory computer readable storage medium is disclosed according to Statement 15, wherein the instructions further include to: actuate a device to create the pressure pulse in the fluidic channel.

Statement 17: A non-transitory computer readable storage medium is disclosed according to Statement 16, wherein the device includes a valve, the valve is configured to be opened and closed to generate the pressure pulse.

Statement 18: A non-transitory computer readable storage medium is disclosed according to any of preceding Statements 15-17, wherein the instructions further include to: output, when the error is within the predetermined threshold, the forward model; generate, using the forward model, an estimate of cross-sectional variation of the fluidic channel; and output the estimate of cross-sectional variation of the fluidic channel.

Statement 19: A non-transitory computer readable storage medium is disclosed according to Statement 18, wherein the estimate of cross-sectional variation is provided as a function of amount of estimated cross-sectional variation of the fluidic channel versus distance in the fluidic channel from the one or more sensors.

Statement 20: A non-transitory computer readable storage medium is disclosed according to any of preceding Statements 15-19, wherein the instructions further include to: repeat, until the error is within the predetermined threshold, generate the forward model, generate the simulated pressure profile, determine the error, and update the forward model.

The disclosures shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the examples described above may be modified within the scope of the appended claims.

What is claimed is:

1. A method for non-intrusively determining cross-sectional variation of a fluidic channel, the method comprising:
obtaining, from one or more sensors, a measured pressure profile based on at least one pressure pulse induced in a fluidic channel;
generating a forward model of cross-sectional variation of the fluidic channel;
generating, using the forward model, a simulated pressure profile;
determining, using the measured pressure profile and the simulated pressure profile, an error; and
updating, when the error is outside a predetermined threshold, the forward model based on the error.

2. The method of claim 1, further comprising:
actuating a device to create the pressure pulse in the fluidic channel.

3. The method of claim 2, wherein the device includes a valve, the valve is configured to be opened and closed to generate the pressure pulse.

4. The method of claim 1, further comprising:
outputting, when the error is within the predetermined threshold, the forward model;
generating, using the forward model, an estimate of cross-sectional variation of the fluidic channel; and
outputting the estimate of cross-sectional variation of the fluidic channel.

5. The method of claim 4, wherein the estimate of cross-sectional variation is provided as a function of amount of estimated cross-sectional variation of the fluidic channel versus distance in the fluidic channel from the one or more sensors.

6. The method of claim 1, further comprising:
repeating, until the error is within the predetermined threshold, generating the forward model, generating the simulated pressure profile, determining the error, and updating the forward model.

7. The method of claim 1, wherein the cross-sectional variation includes a shape change of the fluidic channel and/or a change of cross-sectional area of the fluidic channel.

8. A system for non-intrusively determining cross-sectional variation of a fluidic channel, the system comprising:
a device operable to induce at least one pressure pulse in a fluidic channel;
one or more sensors operable to measure a pressure profile based on the at least one pressure pulse; and
a non-transitory computer readable storage medium including at least one processor and storing instructions executable by the at least one processor to:
obtain, from the one or more sensors, the measured pressure profile;
generate a forward model of cross-sectional variation of the fluidic channel;
generate, using the forward model, a simulated pressure profile;
determine, using the measured pressure profile and the simulated pressure profile, an error; and
update, when the error is outside a predetermined threshold, the forward model based on the error.

9. The system of claim 8, wherein the device includes a valve, the valve is configured to be opened and closed to generate the pressure pulse.

10. The system of claim 8, wherein the instructions further include to:
output, when the error is within the predetermined threshold, the forward model;
generate, using the forward model, an estimate of cross-sectional variation of the fluidic channel; and
output the estimate of cross-sectional variation of the fluidic channel.

11. The system of claim 10, wherein the estimate of cross-sectional variation is provided as a function of amount of estimated cross-sectional variation of the fluidic channel versus distance in the fluidic channel from the one or more sensors.

12. The system of claim 8, wherein the instructions further include to:
repeat, until the error is within the predetermined threshold, generate the forward model, generate the simulated pressure profile, determine the error, and update the forward model.

13. The system of claim 8, wherein the cross-sectional variation includes a shape change of the fluidic channel.

14. The system of claim 8, wherein the cross-sectional variation includes a change of cross-sectional area of the fluidic channel.

15. A non-transitory computer readable storage medium comprising at least one processor and storing instructions executable by the at least one processor to:
obtain, from one or more sensors, a measured pressure profile based on at least one pressure pulse induced in a fluidic channel;
generate a forward model of cross-sectional variation of the fluidic channel;
generate, using the forward model, a simulated pressure profile;
determine, using the measured pressure profile and the simulated pressure profile, an error; and
update, when the error is outside a predetermined threshold, the forward model based on the error.

16. The non-transitory computer readable storage medium of claim 15, wherein the instructions further include to:
actuate a device to create the pressure pulse in the fluidic channel.

17. The non-transitory computer readable storage medium of claim 16, wherein the device includes a valve, the valve is configured to be opened and closed to generate the pressure pulse.

18. The non-transitory computer readable storage medium of claim 15, wherein the instructions further include to:
output, when the error is within the predetermined threshold, the forward model;
generate, using the forward model, an estimate of cross-sectional variation of the fluidic channel; and
output the estimate of cross-sectional variation of the fluidic channel.

19. The non-transitory computer readable storage medium of claim 18, wherein the estimate of cross-sectional variation is provided as a function of amount of estimated cross-sectional variation of the fluidic channel versus distance in the fluidic channel from the one or more sensors.

20. The non-transitory computer readable storage medium of claim 15, wherein the instructions further include to:
repeat, until the error is within the predetermined threshold, generate the forward model, generate the simulated pressure profile, determine the error, and update the forward model.
